(19) United States
(12) Patent Application Publication
(10) Pub. No.: US 2015/0175403 A1
(43) Pub. Date: Jun. 25, 2015

(54) HORSE SADDLE TREE FRAMEWORK MADE OF COMPOSITE MATERIAL

(71) Applicant: Frederick Marie Courouble, Manhattan Beach, CA (US)

(72) Inventor: Frederick Marie Courouble, Manhattan Beach, CA (US)

(21) Appl. No.: 14/580,039

(22) Filed: Dec. 22, 2014

Related U.S. Application Data
(60) Provisional application No. 61/919,010, filed on Dec. 20, 2013.

(51) Int. Cl. B68C 1/02

(52) U.S. Cl. CPC B68C 1/025

(57) ABSTRACT

A composite saddle tree comprising: a saddle tree frame, a first laminate, and a bonding agent. The first laminate wraps the saddle tree frame. The saddle tree frame further comprises a pommel, having a first pommel leg and a second pommel leg; a gullet, having a first gullet leg and a second gullet leg; a cantle; and a seat. The seat comprises an aperture, extending there through, that connects the first pommel leg and the second pommel leg to the cantle to form one continuous piece therewith. The gullet further comprises a plurality of sheets of a second laminate, extending from the first gullet leg to the second gullet leg, that are stacked to form a leaf spring shape. A bonding agent attaches the first laminate to the saddle tree frame, and each sheet in the second laminate to another sheet in the second laminate.

### CROSS-REFERENCE TO RELATED APPLICATION

The present application claims priority under 35 U.S.C. §119(e) to U.S. Provisional Patent Application No. 61/919,010, entitled “Horse Saddle Tree Framework Made of Composite Material,” and filed Dec. 20, 2013, the disclosure of which is incorporated by reference herein in its entirety.

### BACKGROUND OF THE INVENTION

1. Field of Invention

This invention relates to an improved saddle tree, on which saddles may be built, designed to add strength and flexibility with the use of composite materials while reducing weight over the standard wood saddle tree.

2. Description of Related Art

Saddle trees are the framework around which a saddle is built. For centuries, traditional saddle trees have been constructed out of plain wood or plywood and fashioned to conform, as closely as possible, to the natural anatomical curvature of the back of a horse. These wooden saddle trees are reinforced with pre-formed flat steel metal plates. These reinforcing metal plates are attached to the wooden saddle tree, with the aid of nails or rivets, to provide stiffness and strength to withstand normal usage and loading conditions.

Conventional saddle trees possess various common elements, including three critical regions, a pommel, a cantle and a seat. The pommel is the front raised part of the saddle tree. The arch under the pommel is called the gullet. The cantle is the back raised part of the saddle tree. Between the pommel and the cantle, there is the seat.

The term “pommel”, “gullet”, and “cantle” are all conventional terms of the saddler art and are used in their normal conventional meanings in this specification.

Conventional saddle trees suffer from a number of drawbacks. First, due to the dynamical loading imparted by the rider upon the saddle, conventional saddle trees suffer from excessive torsional and bending deformation, specifically in the cantle and seat areas. This deformation is caused by the main wooden frame's inherent structural weakness coupled with metal shapes of varying thickness reinforced in the three critical regions to prevent structure failure under normal usage. Most of the distortive stresses tend to concentrate in joint areas, where nails are utilized and cannot distribute strain energy evenly over the whole of the saddle tree frame's structure.

Because the critical aim of any viable saddle tree design is to maximize the comfort level experienced by both the rider and the horse, gentle and gradual transition of elastic deformation between the different areas of the saddle must be provided. The use of specific metal plates of a specific thickness to add the desired strength for each region causes a boost in flexural strength in the pommel, which in turn causes a rapid degradation of the much desired flexural rigidity around the seat and the cantle areas.

In this respect, the saddle tree made of composite material substantially increases the strength, resilience and lightens the overall saddle tree.

### SUMMARY OF THE INVENTION

A composite saddle tree comprising: a saddle tree frame, a first laminate, and a bonding agent. The first laminate wraps the saddle tree frame. The saddle tree frame further comprises a pommel, having a first pommel leg and a second pommel leg; a gullet, having a first gullet leg and a second gullet leg; a cantle; and a seat. The seat comprises an aperture, extending there through, that connects the first pommel leg and the second pommel leg to the cantle to form one continuous piece therewith. The gullet further comprises a plurality of sheets of a second laminate, extending from the first gullet leg to the second gullet leg, that are stacked to form a leaf spring shape. A bonding agent attaches the first laminate to the saddle tree frame, and each sheet in the second laminate to another sheet in the second laminate.

The saddle tree frame may be constructed out of wood such as plywood, balsa, or plain wood or high density foam. The fibrous cloth may comprise of carbon fiber, aramid, dyeema, E-Glass, and S-Glass. The bonding agent may comprise of epoxy or a polyester resin. The fibrous cloth may have a unidirectional weave of 0 degrees, 90 degrees, +45 degrees, −45 degrees, or a bidirectional weave of 0/90 degrees or +45 degrees.

### BRIEF DESCRIPTION OF THE DRAWINGS

For a more complete understanding of the present invention, the features and advantages thereof, reference is now made to the ensuing descriptions taken in connection with the accompanying drawings briefly described as follows:

FIG. 1 illustrates a front view of the saddle tree;

FIG. 2 illustrates an exploded profile view of the saddle tree;

FIG. 3 illustrates a profile view of the saddle tree with unattached stirrup bars;

FIG. 4 illustrates an exploded view of the pommel and gullet regions of the saddle tree with the sheets of laminate; and

FIG. 5 illustrates a profile view of the pommel and gullet, showing the sheets of laminate.

### DETAILED DESCRIPTION OF EMBODIMENTS

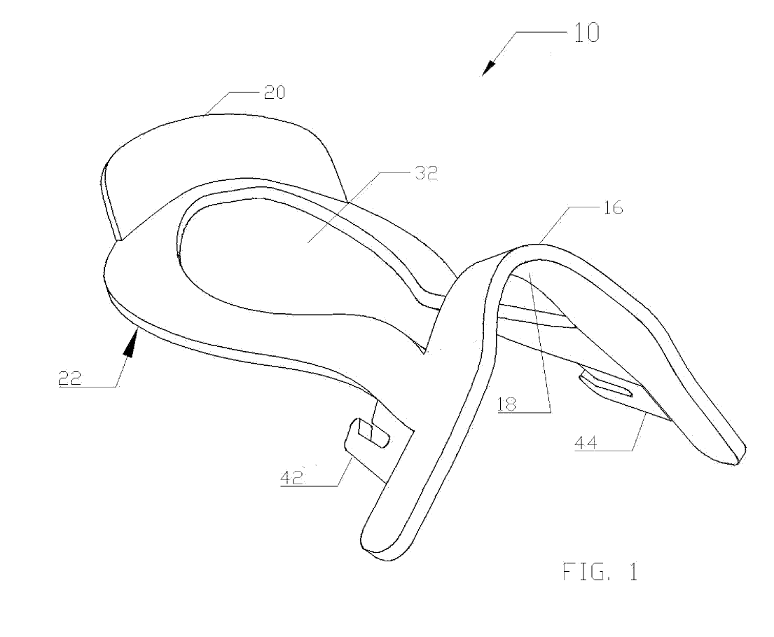

Further features and advantages of the invention, as well as the structure and operation of various embodiments of the invention, are described in detail below with reference to the accompanying FIGS. 1-5, wherein like reference numerals refer to like elements.

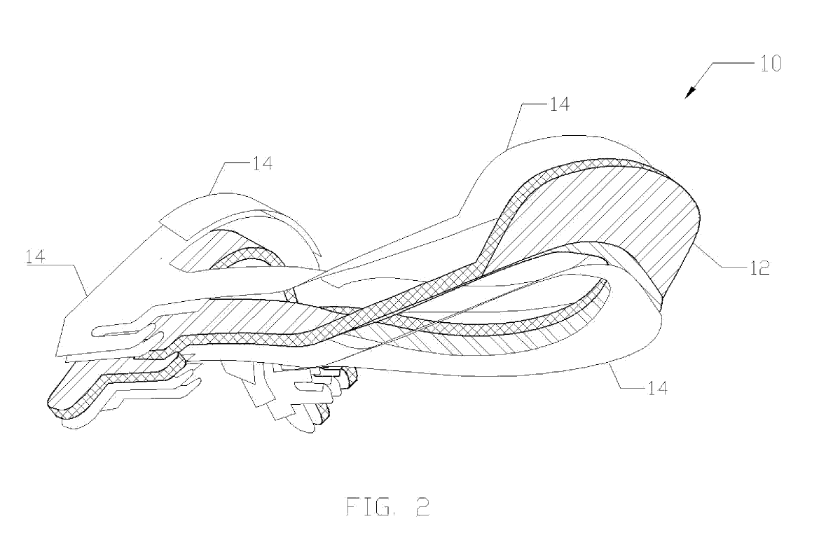

Referring to FIG. 2, the composite saddle tree 10 comprises a saddle tree frame 12, at least one sheet of a first laminate 14, and a bonding agent (not shown) that adheres the first laminate 14 to the saddle tree frame 12.

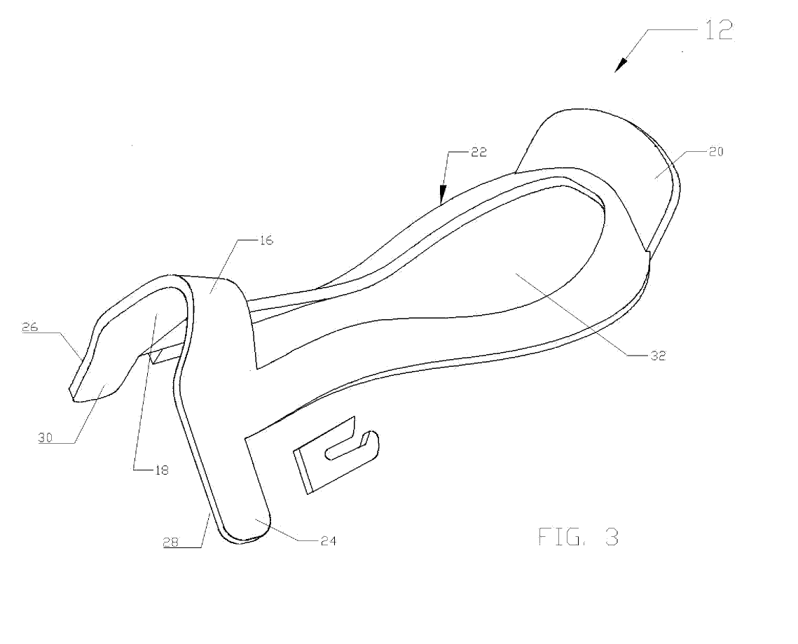

Referring to FIG. 3, the saddle tree frame 12 further comprises a pommel 16, a gullet 18, a cantle 20, and a seat 22. The pommel 16 has an inverted U-shape, and comprises a first pommel leg 24 and a second pommel leg 26. The gullet 18 is the underside of the pommel 16 that comprises a first gullet leg 28 and a second gullet leg 30. The cantle 20 is the back end of the saddle tree frame 12. The seat 22 comprises an aperture 32 that extends there through. The seat 22 connects the first pommel leg 24 and the second pommel leg 26 to the cantle 20, thereby forming one continuous surface from the pommel 16, seat 22, and cantle 20. The aperture 32 in the seat 22 is sized and dimensioned to make the seat 22 look like a pair of bars as shown in FIG. 3. This aperture 32 allows the saddle tree frame 12 to bend and flex more in the seat region in comparison with saddle tree frames that do not have an aperture in the center.

The saddle tree frame 12 may be constructed out of wood (i.e. plywood, balsa, or plain wood), a high density foam, or a combination of these two materials.

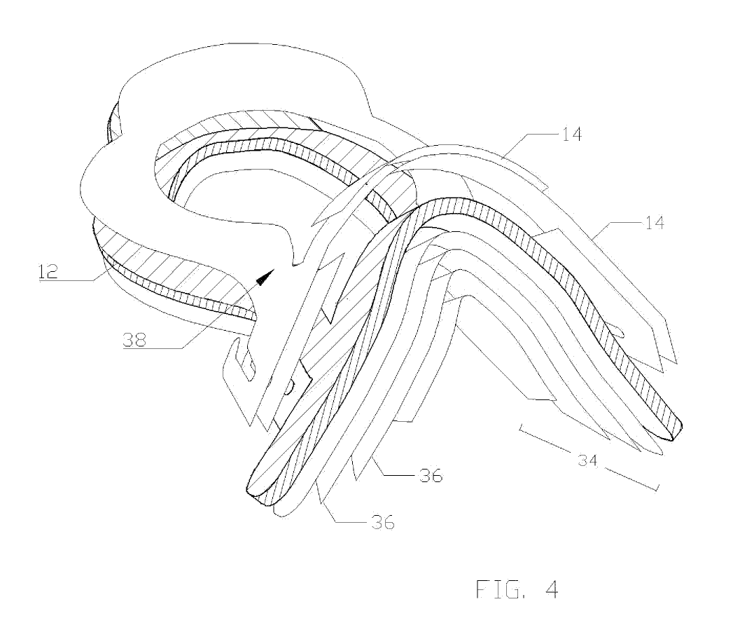

Referring to FIG. 4, the composite saddle tree 10 comprises at least one sheet of a first laminate 14. The first sheet of the first laminate 14 may wrap the pommel 16 on the saddle tree frame 12. The second sheet of the first laminate 14 may wrap the gullet 18. The third sheet of the first laminate 14 may wrap only the seat 22, ending at the base of the cantle 20. Alternatively, the third sheet of the first laminate 14 may wrap both the seat 22 and the cantle 20. It should be noted that the first sheet of the first laminate 14 on the pommel 16 overlaps with the second sheet of the first laminate 14 on the gullet 18 to provide structural continuity. The third sheet of the first laminate 14 on the seat 22 overlaps with both the first sheet of the first laminate 14 on the pommel 16, and the second sheet of the first laminate 14 on the gullet 18 to provide structural continuity. The first laminate 14 comprises a fibrous cloth (i.e. carbon fiber, aramid, dyneema, E-Glass, or S-Glass) in an epoxy based matrix. The fibrous cloth may have a unidirectional weave of 0 degrees, 90 degrees, +45 degrees, −45 degrees, or a bidirectional weave of 0/90 degrees or ±45 degrees.

The weave of the fibrous cloth in the second sheet of the first laminate 14 that covers the seat 22 and cantle 20 areas may have the same weave or a different weave from the fibers in the first sheet of the first laminate 14 on the pommel 16 and the second sheet of the first laminate 14 on the gullet 18, depending on the stiffness required in the seat 22.

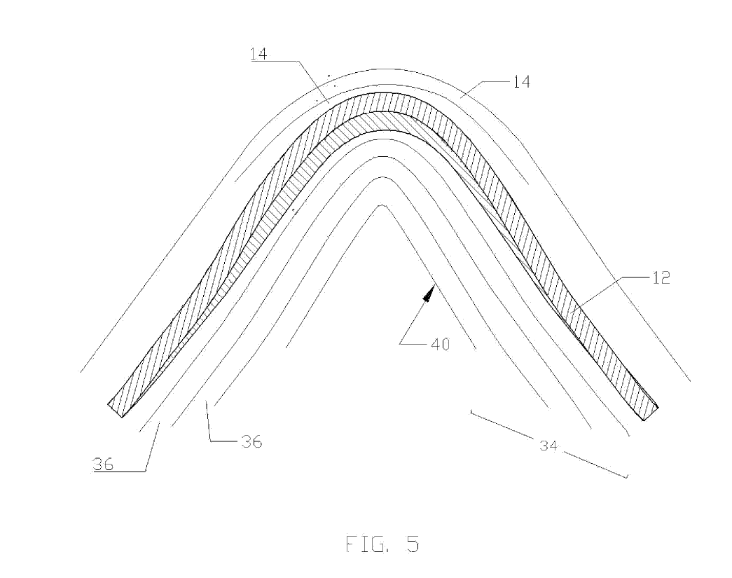

In some embodiments, the pommel 16 may contain more than one sheet of a first laminate 14. As shown in FIGS. 4 and 5, each sheet in the first laminate 14 is sized and dimensioned for the width of the pommel 16, and stacked so that that a staggered shape forms on the pommel 16.

The bonding agent that adheres the first laminate 14 to the saddle tree frame 12 may be epoxy, a polyester resin, or another similar bonding material.

The gullet 18 of the saddle tree frame 12 may further comprise a plurality of sheets of a second laminate 34 as shown in FIG. 4. Similar to the first laminate 14, the second laminate 34 also comprises a fibrous cloth (i.e. carbon fiber, aramid, dyneema, E-Glass, or S-Glass) in an epoxy based matrix. The fibrous cloth may have a bidirectional weave of 0/90 degrees or ±45 degrees. Alternatively, the sheets in the second laminate 34 may have fibers with a unidirectional weave of 0 degrees, 90 degrees, +45 degrees, or −45 degrees. In the preferred embodiment, approximately 50-80% of the sheets in the second laminate 34 have fibers with a weave of 0/90 degrees, and 20-50% of the sheets have fibers with a weave of ±45 degrees. The preferred embodiment may also be comprised of laminates having fibers with a unidirectional weave. In such as case, approximately 50-80% of the sheets in the second laminate 34 have fibers with a weave of 0 degrees or 90 degrees, and 20-50% of the sheets have fibers with a weave of +45 degrees or −45 degrees.

Each sheet 36 in the second laminate 34 is sized and dimensioned for the width of the gullet 18. The first sheet in this second laminate 34 is placed at the intersection 38 of the first gullet leg 28 and the seat 22 and extends to the intersection 38 of the second gullet leg 30 and the seat 22. The fibers in the second sheet of the second laminate 34 have a different weave from the fibers in the first sheet of the second laminate 34. Successive sheets of the second laminate 34 may have fibers in a different weave from the fibers in the previous sheet of the second laminate 34. Each sheet 36 of the second laminate 34 is stacked so that a leaf spring shape 40 forms. This staggered pattern of the second laminates 34 with weaves in different directions allows substantial deflection control at the top or the pommel 16, where rigidity and strength are most desirable to the intersection 38 point where some deflection is needed to complement the curving anatomy of a horse's back. Thus, the composite saddle tree 10 allows for a more tighter and comfortable fit on the horse's back.

Each sheet 36 in the second laminate 34 is bonded to another sheet in the second laminate 34 using epoxy, a polyester resin, or another similar bonding material.

As shown in FIG. 1, the pommel 16 may further comprise a first stirrup bar 44 and a second stirrup bar 42. The first stirrup bar 44 is attached to the first pommel leg 24 in a direction that is parallel to the seat 22. Similarly, the second stirrup bar 42 is attached to the second pommel leg 26 in a direction that is parallel to the seat 22. Unlike traditional saddle tree frames where nails are used to attach the stirrup bars to the legs of the pommel, only a bonding agent (not shown) such as the ones that have been described herein is used to attach the first stirrup bar 44 to the first pommel leg 24 and attach the second stirrup bar 42 to the second pommel leg 26.

Since the first stirrup bar 44 and second stirrup bar 42 are the same, only the first stirrup bar 44 will be described in detail. The first stirrup bar 44 comprises a rectangular core of wood (i.e. plywood, balsa, or plain wood) or fiberglass. A third laminate (not shown) completely wraps the rectangular core of the first stirrup bar 44 and the third laminate extends to cover a portion of the first pommel leg 24. The third laminate comprises a fibrous cloth (i.e. carbon fiber, aramid, dyneema, E-Glass, or S-Glass) in an epoxy based matrix. The fibrous cloth may have a unidirectional weave of 0 degrees, 90 degrees, +45 degrees, −45 degrees, or a bidirectional weave of 0/90 degrees or ±45 degrees. In the preferred embodiment, the rectangular core of the first stirrup bar 44 is wrapped in at least two sheets of the third laminate, having fibers oriented +45 degrees, −45 degrees, or ±45 degrees. Each sheet of the third laminate on the first stirrup bar 44 overlaps with the first sheet of the first laminate 14 on the pommel 16, and the second sheet of the first laminate 14 on the gullet 18 to secure the first stirrup bar 44 to the composite saddle tree 10. Each sheet of the third laminate is bonded to another sheet of the third laminate with epoxy or a polyester resin. it should be noted that the total thickness of the third laminate should at least match the total thickness of the first laminate 14 that covers the saddle tree frame 12 that has been previously described.

The foregoing description of various embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of apparatuses.

I claim:

1. A composite saddle tree comprising:
a saddle tree frame, having
a pommel, having a first pommel leg and a second pommel leg,
a gullet, having a first gullet leg and a second gullet leg,
a cantle, and
a seat, having an aperture extending there through, connecting said first pommel leg and said second pommel leg to said cantle to form one continuous piece therewith,
wherein, said gullet further comprises a plurality of sheets of a first laminate, extending from the first gullet leg to the second gullet leg, that are stacked to form a leaf spring shape;
at least one sheet of a second laminate that wraps said saddle tree frame; and
a bonding agent provided between each sheet in said plurality of sheets of a first laminate, and said second laminate and said saddle tree frame.

2. The composite saddle tree of claim 1, wherein the saddle tree frame comprises at least one of wood and high density foam.

3. The composite saddle tree of claim 1, wherein the bonding agent is selected from the group consisting of epoxy and a polyester resin.

4. The composite saddle tree of claim 1, wherein the first laminate and the second laminate comprises epoxy and a fibrous cloth.

5. The composite saddle tree of claim 4, wherein the fibrous cloth is selected from the group consisting of carbon fiber, aramid, dyneema, E-Glass, and S-Glass.

6. The composite saddle tree of claim 5, wherein the fibrous cloth comprises a weave selected from the group consisting of, 0 degrees, 90 degrees, 0/90 degrees, −45 degrees, +45 degrees, and ±45 degrees.

7. The composite saddle tree of claim 6, wherein at least 50 percent of the sheets in the plurality of sheets of the first laminate comprise a weave selected from the group consisting of 0 degrees, 90 degrees, and 0/90 degrees.

8. The composite saddle tree of claim 1, wherein the pommel further comprises at least one laminated sheet, extending from the first pommel leg to the second pommel leg, that is stacked to form a leaf spring shape.

9. The composite saddle tree of claim 8, wherein the laminated sheet comprises epoxy and a fibrous cloth.

10. The composite saddle tree of claim 9, wherein the fibrous cloth comprises a weave selected from the group consisting of 0 degrees, 90 degrees, 0/90 degrees, −45 degrees, +45 degrees, and ±45 degrees.

11. The composite saddle tree of claim 1 further comprising a first stirrup bar attached to the first pommel leg and a second stirrup bar attached to the second pommel leg, wherein said first stirrup bar and said second stirrup bar are each wrapped in a laminated sheet and a bonding agent is provided between the laminated sheet and each stirrup bar.

12. The composite saddle tree of claim 11, wherein the bonding agent is selected from the group consisting of epoxy base and a polyester resin.

13. The composite saddle tree of claim 11, wherein the first stirrup bar and the second stirrup bar are composed of at least one of wood and fiberglass.

14. The composite saddle tree of claim 11, wherein the laminated sheet that wraps the first stirrup bar and the second stirrup bar comprises epoxy and a fibrous cloth.

15. The composite saddle tree of claim 11, wherein the fibrous cloth is selected from the group consisting of carbon fiber, aramid, dyneema, E-Glass, and S-Glass.

16. The composite saddle tree of claim 11, wherein the fibrous cloth comprises a weave selected from the group consisting of 0 degrees, 90 degrees, 0/90 degrees, −45 degrees, +45 degrees, and ±45 degrees.
